(19) United States
(12) Patent Application Publication
(10) Pub. No.: US 2008/0175699 A1
(43) Pub. Date: Jul. 24, 2008

(54) Portable fabrication trailer for structural metal members

(76) Inventor: Zonnie Clifton Singleton, West Melbourne, FL (US)

Correspondence Address: LOREN G. HELMREICH, 5718 WESTHEIMER, SUITE 1800, HOUSTON, TX, 77057, US

(21) Appl. No.: 11/657,678

(22) Filed: Jan. 24, 2007

(51) Int. Cl. B60P 3/025; B21D 31/00; B66C 19/00

(52) U.S. Cl. 414/458; 212/312; 72/362

(57) ABSTRACT

A portable trailer 10 for fabricating structural metal members suitable for a building at a job site comprises a trailer frame 12 having a plurality of side panels, a roof, and a floor defining a trailer interior. One or more dollies 30 is removably attachable to and attachable from the trailer frame, and support the trailer frame during transport. When at the job site, one or more dollies are removed from under the trailer frame, which is lowered to an operating position. One or more metal member fabricating machines 40 are positioned within the trailer interior. The machines are preferably movable from a transport position to an operating position.

### FIELD OF THE INVENTION

The present invention relates to portable trailers for fabricating metal members. More particularly, the invention relates to a portable trailer for housing one or more metal member fabricating machines, such as insulated panels, trusses, or wall panels for a building.

### BACKGROUND OF THE INVENTION

An increasing number of structures, and particularly homes and apartments, are being fabricated with structural metal members, such as steel insulating panels, cold formed steel trusses, and panelized steel wall systems. Machines for forming these metal components are conventionally located in factories, and the metal members are manufactured and shipped to the job site where they are assembled. A significant disadvantage of this technique has been known for a long time. If a particular job is “short” on one or more members, significant delays may result from the time required to ship the short members from the factory to the job site. In other cases, shipped metal components can become damaged during transport, or may not be adequately secured at a job site. Improved techniques are thus required to lower the cost to fabricate buildings with metal components, and to increase the efficiency of construction personnel so that delays in finishing a job are minimized.

U.S. Pat. No. 6,813,919 discloses a steel building frame formed from a coil. Coil forming equipment is portable and may be located at the job site. U.S. Pat. No. 5,359,871 discloses microprocessor controlled equipment for fabricating metal building panels. Application U.S. 2005/0229528 discloses a system for manufacturing trusses, and indicates that the assembly of the trusses may occur at the job site. Forming a machine for bending metal strips is disclosed in U.S. Pat. No. 5,425,259, and a panel roofing machine is disclosed in U.S. Pat. No. 4,864,837. An early type of mobile metal forming machine for producing metal siding is disclosed in U.S. Pat. No. 3,710,607. U.S. Pat. No. 4,660,399 discloses another version of a mobile roll forming machine. The assembly includes jack stands at the corners of the frame for leveling and supporting the machines during use. U.S. Pat. No. 5,315,853 discloses a portable construction frame forming machine with a trailer tongue for connection to a powered vehicle.

More recently, U.S. Pat. No. 5,960,662 discloses a technique for attaching a crane to a sheet metal rail forming machine. Hydraulically powered jacks stabilize the frame at a construction site. U.S. Pat. No. 6,325,435 discloses a material fabrication mobile trailer which provides area lighting and ventilation. The patent discloses electrical power drawn from an on-site source or from a power generator. U.S. Pat. No. 6,772,616 discloses techniques for fabricating roof panels, siding panels and gutters. The machine is provided on tracks which are housed within a framed enclosure.

The above patents do not disclose a highly versatile and relatively low cost portable system for forming various types of structural metal goods at a job site. The disadvantages of the prior art are overcome by the present invention, and an improved trailer and method of fabricating structural metal members is hereinafter disclosed.

### SUMMARY OF THE INVENTION

In one embodiment, a portable trailer is provided for fabricating structural metal members for a building at a job site. The trailer frame supports a front panel, a left-side panel, a right-side panel, a rear panel, a roof, and a floor, with a plurality of panels from a roof and floor defining a trailer interior. One or more dollies are removably attached to or detachable from the trailer frame, and support the trailer frame during transport. The dollies are detached from the trailer frame at a job site to lower the floor from a transport position to an operating position. One or more metal member fabricating machines are positioned within the trailer interior, and may be movable along the floor from a transport position to an operating position.

These and further features and advantages of the present invention will become apparent from the following detailed description, wherein reference is made to the figures in the accompanying drawings.

### BRIEF DESCRIPTION OF THE DRAWINGS

FIG. 1 is a left-side view of the trailer according to the present invention, and with jacks lowered to support the trailer frame.

FIG. 2 is a right-side view of the trailer as shown in FIG. 1, with the jacks raised above the dolly.

FIG. 3 illustrates the trailer frame lowered to an operating position, and the trailer tongue removed.

FIG. 4 is a pictorial view of a dolly removed from the trailer frame.

FIG. 5 illustrates the trailer in an operating position with a delivery truck bed above the floor of the trailer and the panels opened.

FIG. 6 illustrates metal member fabricating machines.

### DETAILED DESCRIPTION OF PREFERRED EMBODIMENTS

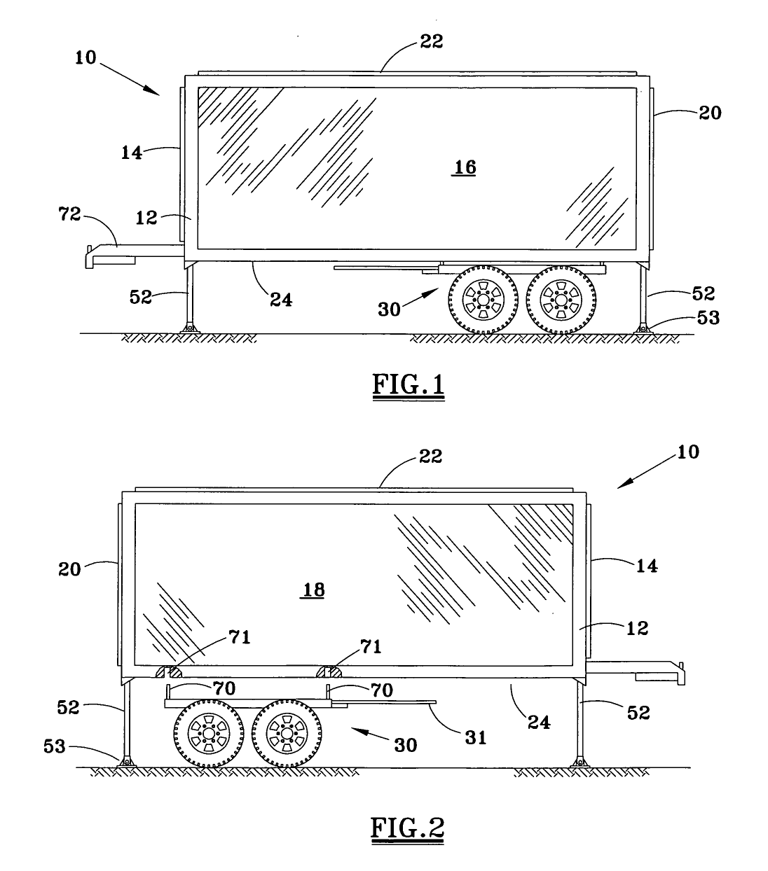

Referring to FIG. 1, a portable trailer 10 is shown for fabricating structural metal members for a building at a job site. Various types of structural metal members may be fabricated using the trailer while positioned at a job site, including metal insulating panels, cold formed steel trusses, and panelized wall systems. As shown in FIGS. 1 and 2, a trailer frame includes a front panel 14 which may be permanently attached to the trailer frame, a left-side panel 16, a right-side panel 18, and a rear panel 20, each of which preferably are movable with respect to the trailer frame, as discussed below. Those skilled in the art will appreciate that the panels are simplistically disclosed, and that various types of panels and various configurations of a roof and floor may be provided for forming the interior of the trailer. The trailer also includes a roof 22 and a floor 24 which define a trailer interior. The trailer as shown may thus securely house fabricating equipment, and protect the equipment from the environment.

FIG. 1 also illustrates the trailer frame 12 while supported by a dolly 30, which preferably includes a plurality of axles. One or more dollies may be removably attached to the trailer frame to support the trailer frame during transport, and may be detachable from the trailer frame while at the job site so that the floor of the trailer can be lowered to an operating position. The trailer preferably includes a plurality of hydraulic jacks 52, each having a ground engaging pad 53 at a lower end. For most embodiments, four hydraulic jacks may serve the desired purpose, although jacks intermediate the front panel and the rear panel may be provided, if desired. Those skilled in the art will appreciate that during transport, the trailer may closely resemble the FIG. 1 design, except that the hydraulic jacks 52 will be activated so that the pads 53 are raised substantially from the ground, and preferably are locked into a raised position closely adjacent the lower portion of the frame for transport. FIG. 1 also shows a tongue 22 attached to the trailer frame for transport.

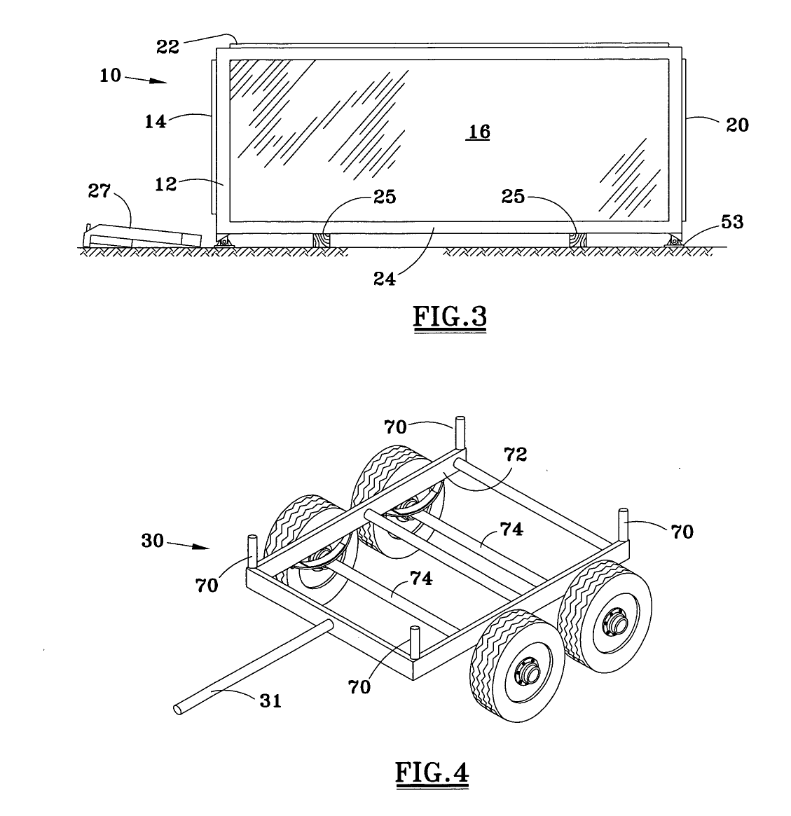

Referring again to FIG. 2, the hydraulic jacks 52 as shown activated to raise the floor of the trailer frame so that it disengages the dolly 30. As explained below, each jack 56 is separately controllable. The dolly 30 may then be easily removed from beneath the trailer frame by manipulating the dolly tongue 31. Once the dolly 30 is removed, the hydraulic jacks 52 may be simultaneously lowered so that the floor 24 preferably rests on the ground, or is spaced slightly above the ground by spacers. A majority of the weight of the trailer and its contents are thus directly transmitted from the frame to the ground. If the frame would not directly engage the ground, the desired stability may be provided by movable spacers, such as 4×4 wooden beams 25 as shown in FIG. 3, so that the frame rests on both the pads 53 and the beams 25. FIGS. 3 shows the tongue 27 removed from the frame.

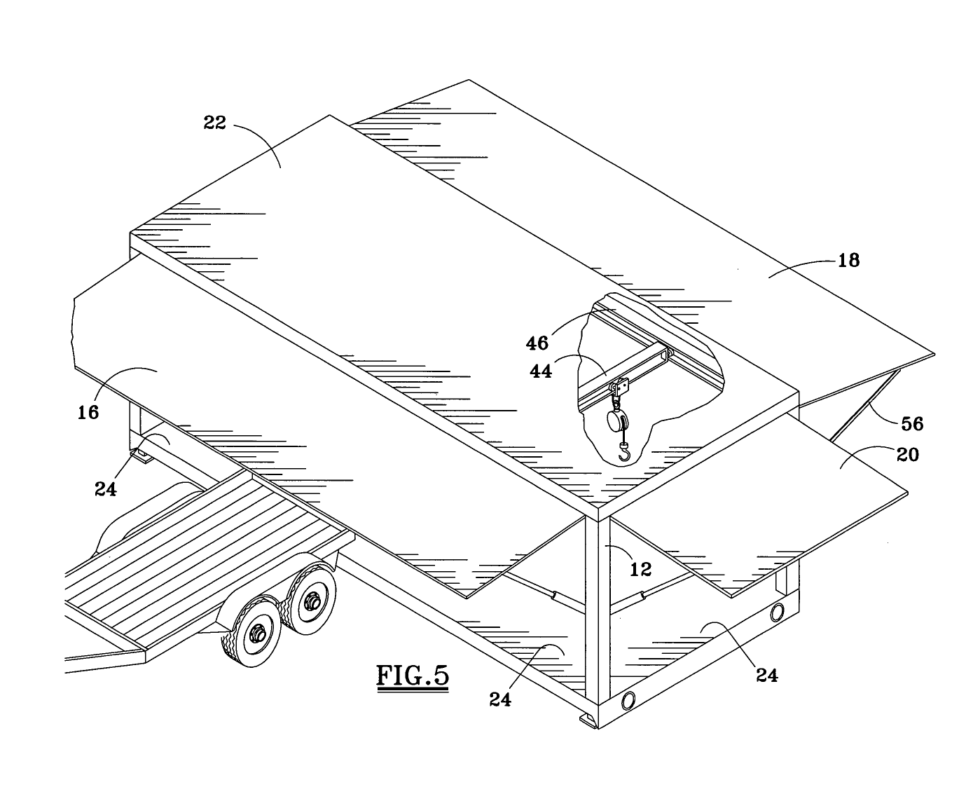

Referring now to FIG. 4, a suitable dolly 30 includes a dolly frame 72 supported on a pair of axles 74, thereby providing sufficient support for the transport of the trailer. While various types of mechanisms may be used for attaching and detaching the dolly 30 from the trailer, the preferred technique utilizes a plurality of pins 70 projecting upward from the frame 72. Each of the pins is thus received within a suitable cavity in the frame 12, thereby structurally securing the frame 12 on the dolly 30 during transport. When the hydraulic cylinders are activated to raise the frame, the pins 70 simply slide out of holes or cavities 71 in the frame, as shown in FIG. 2, and the dolly may be removed, as discussed above.

FIG. 5 illustrates the trailer frame resting on the ground at the job site, although the metal fabricating machines within the trailer interior are not shown for clarity of the depicted components. During use of the trailer, a left-side panel 16, the right-side panel 18, and the rear panel 20 may each be pivoted relative to the frame 12, so that they are movable between a transport position as shown in FIGS. 1 and 2, and an operating position as shown in FIG. 5.

FIG. 5 illustrates that a plurality of hydraulic cylinders 54 may be actuated to raise the panel 16, 18, 20 from a transport position to an operating position. Hydraulic cylinders 54 may be powered from the same hydraulic source as the cylinders 52. Once in a raised position, the panels will be temporarily locked in that position by a conventional locking arm 56.

FIG. 5 illustrates a significant feature of the invention, namely that in the operating position the floor 24 has an upper operating surface 25 which is sufficiently close to the ground that a portion of the bed of a transport trailer or truck may be positioned to overhang the floor 24, as shown in FIG. 5. This substantially facilitates the ease of unloading the wound metal coils from the delivery vehicle utilizing an overhead crane within the enclosure, with the crane including a supporting left-to-right extending beam 44, and also front-to-back extending beam 46. In combination with the hoist 42, the metal rolls may be easily and reliably removed from the coil delivery vehicle. Another significant feature of the invention is that the coil delivery vehicle may unload one or more metal coils for the fabricating equipment within the trailer by positioning the delivery vehicle on either the left-side of the trailer, as shown in FIG. 5, or on the opposing right-side of the trailer. This feature also allows the coil to be delivered to either of two metal fabricating machines without disrupting the operation of the other machine.

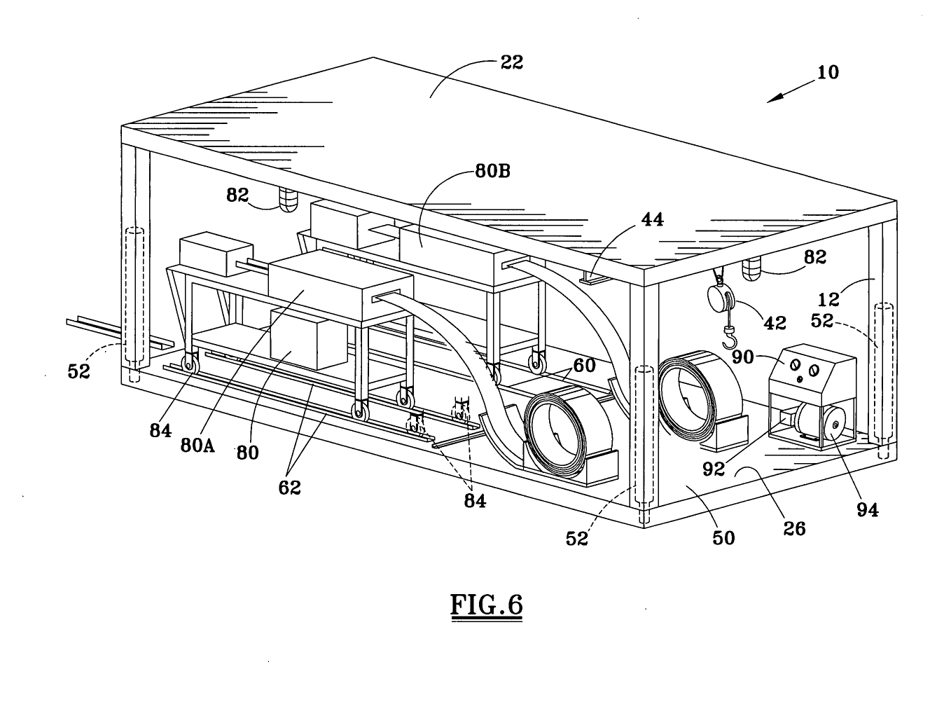

FIG. 6 illustrates equipment within the interior of the trailer, with the two side panels, the front panel, and the rear panel have been removed for clarity. A diesel powered electric generator unit 96 may be provided exterior of the trailer, and may supply both 110 volt and 220 volt power to the trailer. Within the interior of the trailer, a pump 92 is powered by a motor 94 for supplying hydraulic power to the cylinders discussed above, and also to the fabricating equipment discussed below. Control panel 90 is provided for regulating flow from the pump to the various cylinders, and as previously noted each of the cylinders for raising and lowering the trailer may be individually powered. This allows precise leveling of the trailer even if the terrain is uneven, resulting in one of the rounding engaging pads being significantly higher or lower than other of the ground engaging pads.

The generator 96 may supply electrical power directly to the fabricating machines, and to the lighting system 82 within the interior of the trailer. A suitable electrical power generator 96 may be a 25 kw unit which supplies three phase 220 volt or single phase 110 volt to components within the trailer. In other embodiments, an electric generator 96 may not be required, since electrical power may be available at the job site. FIG. 6 also shows a hoist 42 for vertical movement of the load by the crane.

FIG. 6 simplistically illustrates two metal member fabricating machines 80A, 80B. A particular feature of the invention is that one type of metal fabricating machine 80A is customarily used for fabricating various types of panels and panelized wall systems, and another type of fabricating machine 80B is used to fabricate steel trusses. Each of these machines is supplied with conventional coil steel from a steel roll, and outputs products through the rear of the trailer. Each of the metal fabricating machines 80A, 80B is movable along the floor from the transport position to an operating position. In FIG. 6, rollers 84 as shown in solid lines are in the operating position, and the rollers 84 as shown in dashed lines are in the transport position. A track system 60 is provided along the floor and includes raised guides 62 for guiding movement of the fabricating machine from the transport position to an operating position. In one embodiment, the guides 62 comprise angular members having an apex spaced above the floor. The guides 62 thus assist in uniformly and reliably moving the fabricating equipment 80 from a substantially stationary position wherein the equipment is locked into position for its operation, and another stationary position where the equipment is moved and locked in another position within the interior of the trailer and better positioned for transport. The wheels 84 at the base of the equipment may thus be provided with conventional locking mechanisms, or chocks may be used to prohibit linear movement of the equipment when in the desired position.

FIG. 6 also illustrates another feature of the invention, namely that the hydraulically powered cylinders 52 which raise and lower the frame 12 are positioned with one cylinder closely adjacent each of the four corners of the trailer. More particularly, the cylinder end may be welded or otherwise secured to the frame, with the rod end projecting downward for engagement with the pad 53. By positioning a cylinder closely adjacent each corner, the available room for moving men and equipment into and out of the trailer is not restricted. In a preferred embodiment, at least a portion of the cylinder 52 may be securely attached or housed within an interior of a respective corner post of the frame, as shown in FIG. 7, so that the cylinders 52 may have a long length and a sizable diameter, but do not take up any appreciable amount of room within the enclosure. As previously noted, the cylinders 52 as well as the cylinders 54 may be powered by the hydraulic pump 92, and the operation of these cylinders may be automatically controlled or manually controlled by an operator at control panel 90.

Various modifications to the trailer will be apparent to those skilled in the art. Additional fabricating machines may be provided within the trailer, and the equipment could be oriented so that the fabricated product was passed out the front end of the trailer if the front panel is made removable.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A portable trailer for fabricating structural metal members for a building at a job site, the trailer comprising:
a trailer frame supporting a front panel, a left-side panel, a right-side panel, a rear panel, a roof, and a floor, the plurality of panels, roof, and floor defining a trailer interior;
one or more dollies removably attachable to or detachable from the trailer frame, the one or more dollies supporting the trailer frame during transport, and detachable from the trailer frame at the job site to lower the floor from a transport position to an operating position; and
one or more metal member fabricating machines within the trailer interior.

2. A portable trailer as defined in claim 1, further comprising:
a crane secured to the trailer frame and positioned within the trailer interior for unloading coiled metal for the one or more fabricating machines.

3. A portable trailer as defined in claim 3, wherein the crane is a bridge crane for positioning a load left-to-right and front-to-rear within the trailer interior.

4. A portable trailer as defined in claim 3, wherein the crane unloads goods from a coil delivery truck positioned on the left-side of the trailer and unloads goods from the coil delivery truck positioned on the right-side of the trailer.

5. A portable trailer as defined in claim 1, further comprising:
a hydraulic power source supported on the trailer frame; and
a plurality of hydraulic cylinders powered by the hydraulic power source for raising the trailer frame to remove the one or more dollies at the job site and for subsequently lowering the trailer frame to the operating position below the transport position.

6. A portable trailer as defined in claim 1, wherein a majority of each of the left-side panel, the right-side panel and the rear panel are movable with respect to the frame from a transport position to an operating position.

7. A portable trailer as defined in claim 6, further comprising:
a hydraulic power source supported on the trailer frame;
the one or more fabricating machines are hydraulically powered by the hydraulic power source; and
a plurality of hydraulic panel cylinders for moving one or more panels between the transport position and the operating position, the plurality of the hydraulic panel cylinder powered by the hydraulic power source.

8. A portable trailer as defined in claim 1, wherein each of the one or more metal member fabricating machine is movable along the floor from a transport position to an operating position.

9. A portable trailer as defined in claim 8, further comprising:
a track system on the floor of the trailer, the track system including raised guides for guiding movement of the one or more fabricating machines from the transport position to the operating position.

10. A portable trailer as defined in claim 9, wherein the guides comprise spaced apart elongate angular members having an apex above the floor.

11. A portable trailer as defined in claim 1, further comprising:
a plurality of upwardly projecting pins on the one or more dollies for attaching the frame to the one or more dollies during transport.

12. A portable trailer as defined in claim 1, further comprising:
an electrical power source separate from the trailer; and
each of the one or more metal member fabricating machines is supplied with electrical power from the power source; and
the electrical power source powers a lighting system within the trailer interior.

13. A portable trailer as defined in claim 1, further comprising:
a detachable tow bar removably attached to a front portion of the frame.

14. A portable trailer for fabricating structural metal members for a building at a job site, the trailer comprising:
a trailer frame supporting a front panel, a left-side panel, a right-side panel, a rear panel, a roof, and a floor, the plurality of panels, roof, and floor defining a trailer interior;
one or more dollies removably attachable to or detachable from the trailer frame, the one or more dollies supporting the trailer frame during transport, and detachable from the trailer frame at the job site to lower the floor from a transport position to an operating position;
two or more metal member fabricating machines within the trailer interior;
a crane secured to the trailer frame and positioned within the trailer interior for unloading coiled metal for the one or more fabricating machines;
a hydraulic power source supported on the trailer frame; and
a plurality of hydraulic cylinders powered by the hydraulic power source for raising the trailer frame to remove the one or more dollies at the job site and for subsequently lowering the trailer frame to the operating position below the transport position.

15. A portable trailer as defined in claim 14, wherein the crane is a bridge crane for positioning a load left-to-right and front-to-rear within the trailer interior.

16. A portable trailer as defined in claim 15, wherein the crane unloads goods from a coil delivery truck positioned on the left-side of the trailer and unloads goods from the coil delivery truck positioned on the right-side of the trailer.

17. A portable trailer as defined in claim 14, wherein each of the two or more metal member fabricating machine is movable along the floor from a transport position to an operating position.

18. A portable trailer as defined in claim 17, further comprising:
a track system on the floor of the trailer, the track system including raised guides for guiding movement of the one or more fabricating machines from the transport position to the operating position.

19. A portable trailer as defined in claim 14, wherein a majority of each of the left-side panel, the right-side panel and the rear panel are movable with respect to the frame from a transport position to an operating position.

20. A portable trailer as defined in claim 14, further comprising:
a hydraulic power source supported on the trailer frame;
the one or more fabricating machines are hydraulically powered by the hydraulic power source; and
a plurality of hydraulic panel cylinders for moving one or more panels between the transport position and the operating position, the plurality of the hydraulic panel cylinder powered by the hydraulic power source.

21. A portable trailer as defined in claim 14, further comprising:
a plurality of upwardly projecting pins on the one or more dollies for attaching the frame to the one or more dollies during transport.

22. A method of fabricating structural metal members for a building at a job site, the method comprising:
supporting a front panel, a left-side panel, a right-side panel, a rear panel, a roof, and a floor on a trailer frame, the plurality of panels, roof, and floor defining a trailer interior;
removably attachable one or more dollies to the trailer frame, the one or more dollies supporting the trailer frame during transport;
detaching the one or more dollies from the trailer frame at the job site;
with the one or more dollies detached, lowering the floor from a transport position to an operating position; and
operating one or more metal member fabricating machines within the trailer interior while at the job site.

23. A method as defined in claim 22, wherein each of the one or more metal member fabricating machine is movable along the floor from a transport position to an operating position.

24. A method as defined in claim 22, further comprising:
securing a bridge crane to the trailer frame and positioned within the trailer interior for unloading coiled metal for the one or more fabricating machines.

25. A method as defined in claim 24, wherein the bridge crane may unload goods from a coil delivery truck positioned on the left-side of the trailer and may also unload goods from the coil delivery truck positioned on the right-side of the trailer.

26. A method as defined in claim 22, further comprising:
supporting a hydraulic power source on the trailer frame; and
powering a plurality of hydraulic cylinders with the hydraulic power source for raising the trailer frame to remove the one or more dollies at the job site and for subsequently lowering the trailer frame to the operating position below the transport position.

27. A method as defined in claim 26, wherein a majority of each of the left-side panel, the right-side panel and the rear panel are movable with respect to the frame from a transport position to an operating position.

28. A portable trailer as defined in claim 22, further comprising:
providing a track system on the floor of the trailer, the track system including raised guides for guiding movement of the one or more fabricating machines from the transport position to the operating position.

29. A method as defined in claim 22, further comprising:
providing a plurality of upwardly projecting pins on the one or more dollies for attaching the frame to the one or more dollies during transport.

30. A method as defined in claim 22, further comprising:
providing an electrical power source separate from the frame; and
supplying each of the one or more metal member fabricating machines with electrical power from the power source; and
powering a lighting system within the trailer interior with electrical power from the power source.
